(19) United States
(12) Patent Application Publication
(10) Pub. No.: US 2025/0101222 A1
(43) Pub. Date: Mar. 27, 2025

(54) RESIN COMPOSITION FOR LASER LIGHT TRANSMISSION-SIDE MOLDED ARTICLE, AND MOLDED ARTICLE THEREOF

(71) Applicant: Polyplastics Co., Ltd., Tokyo (JP)

(72) Inventors: Takato Isomura, Fuji-shi, Shizuoka (JP); Koki Nagai, Fuji-shi, Shizuoka (JP); Kazuya Goshima, Fuji-shi, Shizuoka (JP); Hiroki Fukatsu, Fuji-shi, Shizuoka (JP)

(73) Assignee: Polyplastics Co., Ltd., Tokyo (JP)

(21) Appl. No.: 18/729,390

(22) PCT Filed: Jan. 6, 2023
(86) PCT No.: PCT/JP2023/000110

§ 371 Date: Jul. 16, 2024

(30) Foreign Application Priority Data
Jan. 19, 2022 (JP) 2022-006494

(51) Int. Cl. C08L 67/06; B23K 26/70; B23K 103/16; C08K 3/32; C08K 5/29; C08K 7/14

(52) U.S. Cl. CPC C08L 67/06; B23K 26/702; C08K 3/32; C08K 5/29; C08K 7/14; B23K 2103/16; C08K 2003/325; C08K 2201/003; C08L 2201/10; C08L 2205/03

(57) ABSTRACT

A resin composition suitable for manufacturing a laser light transmission-side molded article; and a laser light transmission-side molded article are disclosed. A method for improving the laser light transmission properties of a resin composition molded article is also disclosed. The resin composition includes: 100 parts by mass of a polyalkylene terephthalate resin (A); 10-100 parts by mass of a polycarbonate resin (B); 0.1-3 parts by mass of a carbodiimide compound (C); 0-100 parts by mass of an inorganic filler (D); and an inorganic phosphorus compound (E). The method includes blending 0.1-3 parts by mass of a carbodiimide compound (C) in a resin composition including 100 parts by mass of a polyalkylene terephthalate resin (A), 10-100 parts by mass of a polycarbonate resin (B), 0-100 parts by mass of an inorganic filler (D), and an inorganic phosphorus compound (E).

### TECHNICAL FIELD

The present invention relates to: a resin composition for a laser light transmission-side molded article; and a molded article thereof.

### BACKGROUND ART

Polyalkylene terephthalate resins such as polybutylene terephthalate resins, and the like, have excellent thermal resistance, mechanical strength, dimensional stability, electrical properties, and moldability, and thus, are widely utilized in fields such as the electric/electronic field and the automobile field, etc. Polybutylene terephthalate resins are also very often used in housings for actuators, sensors, and the like, and in such cases, methods of joining with screws, adhesives, and welding, etc., are employed. In recent years, laser welding is also often employed.

However, compared to polycarbonate resins and polystyrene resins or polyamide resins, etc., polyalkylene terephthalate resins have low laser light transmission properties, and thus, are not suitable for laser welding. As a technique for adapting polyalkylene terephthalate resins to laser welding, there is a method of making an alloy by blending a polycarbonate resin or a styrene-based resin in a polybutylene terephthalate resin (for example, Patent Document 1).

Furthermore, hydrolysis is likely to occur when polyalkylene terephthalate resins are used for a long duration in a hot and humid environment. As a technique for raising the hydrolysis resistance of a polyalkylene terephthalate resin, there is a method of adding an epoxy resin or a carbodiimide compound to a resin composition. For example, Patent Document 2 discloses a resin composition for laser welding that includes a thermoplastic polyester-based resin, a prescribed amount of a dye having a prescribed constitution, and a prescribed amount of a carbodiimide compound.
Patent Document 1: JP 2003-292752 A
Patent Document 2: JP 2019-38878 A

### SUMMARY OF INVENTION

When a polyalkylene terephthalate resin is blended with a polycarbonate resin, if retention during molding causes thermal stability to decrease and a transesterification reaction proceeds, there are cases in which crystallization temperature decreases. When the crystallization temperature decreases, it becomes difficult for crystallization to occur, and there is a decrease in qualities such as thermal resistance and mold-release properties during molding. Further, when using a hydrolysis resistance improver such as an epoxy resin, or the like, even if the hydrolysis resistance of a resin composition molded article improves, it may not be possible to obtain a similar improvement in hydrolysis resistance in a laser-welded section as that obtained in the resin composition molded article. Furthermore, in order to weld a thick molded article or shorten a welding step by speeding up the laser irradiation rate, it is preferable for a resin composition for a laser light transmission-side molded article to be capable of realizing a higher laser light transmission rate.

The present inventors discovered that by blending a polycarbonate resin, a carbodiimide compound, and an inorganic phosphorus compound in a polyalkylene terephthalate resin, it is possible to improve the thermal stability of the resin composition, the laser light transmission properties of a molded article, and the hydrolysis resistance of a laser-welded section in a laser-welded article, and thus, were led to the completion of the present invention.

One problem of the present invention is to provide: a resin composition suitable for manufacturing a laser light transmission-side molded article; and a laser light transmission-side molded article.

Another problem of the present invention is to provide a method for improving the laser light transmission properties of a resin composition molded article.

The present invention has the following embodiments.

[1]A resin composition for a laser light transmission-side molded article, the resin composition including: 100 parts by mass of a polyalkylene terephthalate resin (A); 10-100 parts by mass of a polycarbonate resin (B); 0.1-3 parts by mass of a carbodiimide compound (C); 0-100 parts by mass of an inorganic filler (D); and an inorganic phosphorus compound (E).

[2] The resin composition described in [1], wherein when three cycles of an operation involving increasing the temperature from 50° C. to 280° C. at a temperature increase rate of 10° C./minute and thereafter decreasing the temperature to 50° C. at a temperature decrease rate of −10° C./minute are performed, a difference between the crystallization temperature in the first cycle and the crystallization temperature in the third cycle, as measured by differential scanning calorimetry on the basis on JIS K 7121, is 5° C. or less.

[3] The resin composition described in [1] or [2], further including an epoxy resin (F).

[4]A laser light transmission-side molded article including the resin composition described in any one of [1] to [3].

[5]A composite molded article including: a laser light transmission-side molded article including the resin composition described in any one of [1] to [3]; and a laser light absorption-side molded article.

[6]A method for producing a composite molded article in which at least a portion of a first molded article including the resin composition described in any one of [1] to [3] and at least a portion of a second molded article including a resin composition including a polyalkylene terephthalate resin and a laser light absorption agent are stacked, and at least a portion of the first molded article and at least a portion of the second molded article are welded by irradiating a laser light from the first molded article side.

[7]A method for improving laser light transmission properties of a resin composition molded article, the method including blending 0.1-3 parts by mass of a carbodiimide compound (C) in a resin composition including 100 parts by mass of a polyalkylene terephthalate resin (A), 10-100 parts by mass of a polycarbonate resin (B), 0-100 parts by mass of an inorganic filler (D), and an inorganic phosphorus compound (E).

According to the present invention, it is possible to provide: a resin composition suitable for manufacturing a laser light transmission-side molded article; and a laser light transmission-side molded article. According to the present invention, it is possible to provide a method for improving laser light transmission properties of a resin composition molded article.

### BRIEF DESCRIPTION OF DRAWINGS

FIG. 1 is a scanning electron microscope photograph (with a magnification of 10,000) for confirming a dispersion state of a polycarbonate resin (B) in a resin composition of Example 2.

FIG. 2 is a scanning electron microscope photograph (with a magnification of 10,000) for confirming a dispersion state of the polycarbonate resin (B) in a resin composition of Comparative Example 2.

FIG. 3 is a schematic explanatory diagram showing a shape of a test piece used in a laser welding test. (a) is a side view of a test piece which is a laser light transmission-side molded article and (b) is a side view of a test piece which is a laser light absorption-side molded article. The numerical values show dimensions (mm).

FIG. 4 is a schematic explanatory diagram showing a laser light being irradiated in a laser welding test.

### DESCRIPTION OF EMBODIMENTS

Hereinafter, embodiments of the present invention will be described in detail. The present invention is not limited by the following embodiments and can be carried out with the addition of appropriate modifications as long as the effects of the present invention are not hindered. In the case in which a specific explanation described regarding one embodiment also applies to another embodiment, there may be cases in which that explanation is omitted for the other embodiment. The expression “X-Y” herein means “X or more and Y or less”.

[Resin Composition]A resin composition for a laser light transmission-side molded article according to the present embodiment (hereinafter also referred to as simply the “resin composition”) includes: 100 parts by mass of a polyalkylene terephthalate resin (A); 10-100 parts by mass of a polycarbonate resin (B); 0.1-3 parts by mass of a carbodiimide compound (C); 0-100 parts by mass of an inorganic filler (D); and an inorganic phosphorus compound (E).

“For a laser light transmission-side molded article” indicates being used to manufacture, among molded articles for laser welding, a molded article to be used on a laser light transmission-side.

### (Polyalkylene Terephthalate Resin (A))

The polyalkylene terephthalate resin (A) is, among thermoplastic polyester resins obtained by a reaction between a dicarboxylic acid component having, as a main component, a dicarboxylic acid compound and/or an ester-forming derivative thereof, and a diol component having, as a main component, a diol compound and/or an ester-forming derivative thereof, a thermoplastic polyester resin having a dicarboxylic acid compound that has terephthalic acid and/or an ester-forming derivative thereof as a main component, and a diol component that has an alkylene glycol and/or an ester-forming derivative thereof as a main component.

As the polyalkylene terephthalate resin (A), it is also possible to use a copolyester having combined therein a dicarboxylic acid component or diol component other than the those of the main components, and furthermore, as another polymerizable monomer, an oxycarboxylic acid component, a lactone component, or the like (hereinafter, also referred to as copolymerizable monomer).

Examples of the dicarboxylic acid component other than that of the main component include aliphatic dicarboxylic acids (for example, C₄₋₄₀ dicarboxylic acids such as succinic acid, glutaric acid, adipic acid, pimelic acid, suberic acid, azelaic acid, sebacic acid, undecanedicarboxylic acid, dodecanedicarboxylic acid, hexadecanecarboxylic acid, dimer acid, etc., and preferably a C₄₋₁₄ dicarboxylic acid), alicyclic dicarboxylic acids (for example, C₄-40 dicarboxylic acids such as hexahydrophthalic acid, hexahydroisophthalic acid, hexahydroterephthalic acid, himic acid, etc., and preferably a C₈₋₁₂ dicarboxylic acid), aromatic dicarboxylic acids other than terephthalic acid (for example, C₈-16 dicarboxylic acids such as phthalic acid, isophthalic acid, methylisophthalic acid, methylterephthalic acid, a naphthalenedicarboxylic acid such as 2,6-naphthalenedicarboxylic acid, or the like, 4,4′-biphenylcarboxylic acid, 4,4′-diphenoxyetherdicarboxylic acid, 4,4′-dioxybenzoic acid, 4,4′-diphenylmethanedicarboxylic acid, 4,4′-diphenylketonedicarboxylic acid, etc.) or a derivative thereof (for example, a derivative capable of forming an ester such as a lower alkyl ester, an aryl ester, an acid anhydride, etc.). Examples of a preferred dicarboxylic acid component to be used in combination with terephthalic acid include isophthalic acid, naphthalenedicarboxylic acid, and the like, and two or more types thereof may be combined and used. Note that preferably 50 mol % or more, further preferably 80 mol % or more, and particularly preferably 90 mol % or more of the dicarboxlyic acid component as a copolymerizable monomer should be an aromatic dicarboxylic acid compound. Furthermore, a polyvalent carboxylic acid such as trimellitic acid, pyromellitic acid, etc., or an ester-forming derivative thereof (alcohol esters, or the like), etc., may be also used as necessary. When such a polyfunctional compound is also used, it is possible to obtain a branched polyalkylene terephthalate resin.

Examples of the diol component other than that of the main component include aliphatic alkanediols (for example, C₂₋₁₂ aliphatic diols such as ethylene glycol, trimethylene glycol, propylene glycol, 1,4-butanediol, 1,3-butanediol, neopentyl glycol, hexanediol, octanediol, decanediol, etc., and preferably an aliphatic alkanediol from among C₂₋₁₀ aliphatic diols other than that used as a main component), polyoxyalkylene glycol (a glycol having a plurality of C₂₋₄ oxyalkylene units; for example, diethylene glycol, dipropylene glycol, ditetramethylene glycol, triethylene glycol, tripropylene glycol, polytetramethylene glycol, etc.), alicyclic diols (for example, 1,4-cyclohexanediol, 1,4-cyclohexanedimethanol, hydrogenated bisphenol A, etc.). Further, it is also possible to use an aromatic diol such as hydroquinone, resorcinol, bisphenol, 2,2-bis(4-hydroxyphenyl)propane, 2,2-bis-(4-2-hydroxyethoxy)phenyl)propane, xylylene glycol, or the like. Note that preferably 50 mol % or more, further preferably 80 mol % or more, and particularly preferably 90 mol % or more of the total diol component as a copolymerizable monomer should be an alkylene glycol. Furthermore, a polyol such as glycerin, trimethylolpropane, trimethyloethane, pentaerythritol etc., or an ester-forming derivative thereof (or the like), etc., may be also used as necessary. When such a polyfunctional compound is also used, it is possible to obtain a branched polyalkylene terephthalate resin.

The oxycarboxylic acid (or the oxycarboxylic acid component or oxycarboxylic acids) includes, for example, an oxycarboxylic acid such as oxybenzoic acid, oxynaphthoic acid, hydroxyphenylacetic acid, glycolic acid, oxycaproic acid, etc., and derivatives thereof. The lactone includes C₃₋₁₂ lactones such as propiolactone, butyrolactone, valerolactone, caprolactone (for example, s-caprolactone, etc.).

Note that it is possible to select the proportion of the copolymerizable monomer in the copolyester from a range of, for example, approximately 0.01 mol % or more to 30 mol % or less with respect to the monomer as a whole. In one embodiment, the proportion of the copolymerizable monomer with respect to the monomer as a whole is approximately 1 mol % or more and 25 mol % or less, preferably approximately 3 mol % or more and 20 mol % or less, and further preferably approximately 5 mol % or more and 15 mol % or less. Further, in the case in which a homopolyester and a copolyester are combined and used, the proportion of the copolyester with respect to the total amount (100 mol %) of the homopolyester and the copolyester can be selected from a range of approximately 0.01 mol % more to 30 mol % or less (preferably approximately 1 mol % or more and 25 mol % or less, further preferably approximately 3 mol % or more and 20 mol % or less, and particularly preferably approximately 5 mol % or more and 15 mol % or less). In one embodiment, the above proportion can be selected from a range of approximately homopolyester/copolyester=99/1-1/99 (mass ratio), preferably 95/5-5/95 (mass ratio), and further preferably 90/10-10/90 (mass ratio).

A preferred polyalkylene terephthalate resin (A) includes a homopolyester or copolyester having an alkylene terephthalate unit as a main component (for example, approximately 50-100 mol % and preferably 75-100%) (for example, a homopolyester such as a C₂₋₄ alkylene terephthalate such as polyethylene terephthalate (PET), polytrimethylene terephthalate (PTT), polybutylene terephthalate (PBT), or the like; a copolyester that has an alkylene terephthalate unit as a main component and contains an alkylene isophthalate unit in a compolyermization component; a copolyester that has an alkylene terephthalate unit as a main component and contains an alkylene naphthlate unit in a copolymerization component, etc.), and these can be used alone or in a combination of two or more.

A particularly preferred polyalkylene terephthalate resin (A) is a homopolyester resin or copolyester resin that includes 80 mol % or more (in particular, 90 mol % or more) of a C₂₋₄ alkylene terephthalate unit such as ethylene terephthalate, trimethylene terephthalate, tetramethylene terephthalate, or the like (for example, a polyethylene terephthalate resin, a polytrimethylene terephthalate resin, a polybutylene terephthalate resin, an isophthalic acid-modified polyethylene terephthalate resin, an isophthalic acid-modified polytrimethylene terephthalate resin, an isophthalic acid-modified polybutylene terephthalate resin, a naphthlalenedicarboxylic acid-modified polyethylene terephthalate resin, a naphthlalenedicarboxylic acid-modified polytrimethylene terephthalate resin, a naphthlalenedicarboxylic acid-modified polybutylene terephthalate resin, or the like).

Among the foregoing, polyethylene terephthalate resins and/or polybutylene terephthalate resins are preferred, with polybutylene terephthalate resins being particularly preferred.

There are no limitations regarding the amount of terminal carboxy groups in the polyalkylene terephthalate resin (A) as long as the effects of the present invention are not hindered. The amount of terminal carboxy groups in the polyalkylene terephthalate resin (A) is preferably 30 meq/kg or less and more preferably 25 meq/kg or less.

The intrinsic viscosity of the polyalkylene terephthalate resin (A) is not particularly limited as long as the effects of the present invention are not hindered. The intrinsic viscosity of the polyalkylene terephthalate resin is preferably 0.6-1.3 dL/g and more preferably 0.65-1.2 dL/g. When a polyalkylene terephthalate resin having an intrinsic viscosity in such a range is used, the obtained resin composition has particularly excellent moldability. Further, it is also possible to adjust the intrinsic viscosity by blending polyalkylene terephthalate resins having different intrinsic viscosities. For example, by blending a polyalkylene terephthalate resin having an intrinsic viscosity of 1.0 dL/g with a polyalkylene terephthalate resin having an intrinsic viscosity of 0.8 dL/g, a polyalkylene terephthalate resin having an intrinsic viscosity of 0.9 dL/g can be prepared. The intrinsic viscosity of the polyalkylene terephthalate resin (A) can be measured, for example, in o-chlorophenol under conditions of a temperature of 35° C.

Note that a commercially available product may be used as the polyalkylene terephthalate resin (A), and it is also possible to use a resin manufactured by copolymerizing (polycondensing) a carboxylic component or a reactive derivative thereof, a diol component or a reactive derivative thereof, and, as necessary, a copolymerizable monomer, by a conventional method such as, for example, transesterification, direct esterification, or the like.

### (Polycarbonate Resin (B))

The resin composition includes 10-100 parts by mass of a polycarbonate resin (B) with respect to 100 parts by mass of the polyalkylene terephthalate resin (A). It was discovered that by blending the polycarbonate resin (B) in the polyalkylene terephthalate resin (A) and further adding the carbodiimide compound (C) described later, it is possible to raise the thermal stability of the resin composition during retention, the laser light transmission rate of a molded article, and the hydrolysis resistance of a welded section of a laser-welded molded article.

Examples of the polycarbonate resin (B) (PC resin) include polymers obtained by a reaction between a dihydroxy compound and phosgene or a carbonate ester such as diphenyl carbonate. The dihydroxy compound may be an alicyclic compound, etc., such as a cycloaliphatic diol, but is preferably an aromatic compound and more preferably a bisphenol compound. The dihydroxy compound may be used alone or as a combination of two or more.

Examples of the bisphenol compound include: bis(hydroxyaryl) C₁₋₁₀ alkanes such as bis(4-hydroxyphenyl)methane, bis(4-hydroxy-3-methylphenyl)methane, 1,1-bis(4-hydroxyphenyl)ethane, 1,1-bis(4-hydroxy-3-methylphenyl)ethane, 1,1-bis(4-hydroxyphenyl)propane, 2,2-bis(4-hydroxyphenyl)propane (bisphenol A), 2,2-bis(4-hydroxy-3-methylphenyl)propane, 2,2-bis(4-hydroxy-3,5-dimethylphenyl)propane, 2,2-bis(4-hydroxy-3-ethylphenyl)propane, 2,2-bis(4-hydroxy-3-t-butylphenyl)propane, 2,2-bis(4-hydroxy-3-bromophenyl)propane, 2,2-bis(4-hydroxyphenyl)butane, 2,2-bis(4-hydroxyphenyl)-3-methylbutane, 2,2-bis(4-hydroxyphenyl)pentane, 2,2-bis(4-hydroxyphenyl)hexane, 2,2-bis(4-hydroxyphenyl)-4-methylpentane, 2,2-bis(4-hydroxyphenyl)octane, bis(4-hydroxyphenyl)phenylmethane, bis(4-hydroxyphenyl)diphenylmethane, bis(4-hydroxydiphenyl)dibenzylmethane, 1,1-bis(4-hydroxyphenyl)-1-phenylpropane, 2,2,2′,2′-tetrahydro 3,3,3′,3′-tetramethyl-1,1′-spirobi-[1H-indene]-6,6′-diol, etc., and preferably bis(hydroxyaryl) C₁₋₆ alkanes; bis(hydroxyaryl) C₄₋₁₀ cycloalkanes such as 1,1-bis(4-hydroxyphenyl)cyclopentane, 1,1-bis(4-hydroxyphenyl)cyclohexane, etc.; dihydroxyaryl ethers such as 4,4′-dihydroxydiphenyl ether, 4,4′-dihydroxy-3,3′-dimethylphenyl ether, etc.; dihydroxyaryl sulfones such as 4,4′-dihydroxyphenyl sulfone, 4,4′-dihydroxy-3,3′-dimethyldiphenyl sulfone, etc.; dihydroxyaryl sulfides such as 4,4′-dihydroxydiphenyl sulfide, 4,4′-dihydroxy-3,3′-dimethyldiphenyl sulfide, etc.; dihydroxyaryl sulfoxides such as 4,4′-dihydroxydiphenyl sulfoxide, 4,4′-dihydroxy-3,3′-dimethyldiphenyl sulfoxide, etc.; and dihydroxyaryl ketones such as 4,4′-dihydroxydiphenyl ketone, 4,4′-dihydroxy-3,3′-dimethyldiphenyl ketone, etc.

A preferred example of the polycarbonate resin (B) is a bisphenol A polycarbonate.

The polycarbonate resin (B) may be a homopolycarbonate and may be a copolycarbonate. Further, the polycarbonate resin (B) may be used alone or as a combination of two or more.

The melt viscosity of the polycarbonate resin (B) is not limited but a melt viscosity at 300° C. and a shear rate of 1000 sec⁻¹ is preferably 0.1 kPa·s or more, more preferably 0.2 kPa·s or more, and further preferably 0.25 kPa·s or more.

The content of the polycarbonate resin (B) is 10-100 parts by mass, preferably 15-90 parts by mass, more preferably 20-85 parts by mass, and further preferably 22-80 parts by mass with respect to 100 parts by mass of the polyalkylene terephthalate resin (A). In one embodiment, the content of the polycarbonate resin (B) may be 60-85 parts by mass, may be 70-85 parts by mass, and may be 75-85 parts by mass with respect to 100 parts by mass of the polyalkylene terephthalate resin (A). In another embodiment, the content of the polycarbonate resin (B) may be 10-30 parts by mass with respect to 100 parts by mass of the polyalkylene terephthalate resin (A).

In one embodiment, the total content of the polyalkylene terephthalate resin (A) and the polycarbonate resin (B) is preferably 80 mass % or more, more preferably 90 mass % or more, and further preferably 100 mass % of the thermoplastic resin included in the resin composition. In other words, in one embodiment, the content of the thermoplastic resin excluding the polyalkylene terephthalate resin (A) and the polycarbonate resin (B) in the resin composition is preferably 20 mass % or less, more preferably 10 mass % or less, and further preferably 0 in the thermoplastic resin.

In one embodiment, the thermoplastic resin in the resin composition may consist of: at least one polyalkylene terephthalate resin (A) selected from polyethylene terephthalate resins and polybutylene terephthalate resins; and the polycarbonate resin (B). In one embodiment, the thermoplastic resin in the resin composition may consist of: the polyalkylene terephthalate resin (A), which is a polybutylene terephthalate resin; and the polycarbonate resin (B).

### (Carbodiimide Compound (C))

The resin composition includes 0.1-3 parts by mass of a carbodiimide compound (C) with respect to 100 parts by mass of the polyalkylene terephthalate resin (A). By adding the carbodiimide compound (C) to a laser welding resin composition comprising an alloy material of the polyalkylene terephthalate resin (A) and the polycarbonate resin (B), an improvement effect on thermal stability when molten, an improvement effect on the laser light transmission rate of a molded article, and an improvement effect on the hydrolysis resistance of a laser-welded section were confirmed.

Further, when an inorganic phosphorus compound is included, the laser light transmission rate of a molded article may decrease. However, by including the carbodiimide compound (C), it is possible to improve the laser light transmission rate of the molded article even when an inorganic phosphorus compound is included. Furthermore, when a colorant is included, the laser light transmission rate of a molded article tends to decrease. However, by including the carbodiimide compound (C), it is also possible to improve the laser light transmission rate in a resin composition including a colorant compared with a molded article that does not include the carbodiimide compound (C).

As a non-limiting mechanism by which the laser light transmission rate improves, it is thought that adding the carbodiimide compound (C) makes the dispersion diameter of the polycarbonate resin (B) in the resin composition small, and due to being uniformly dispersed, the transmission rate of laser light becomes high.

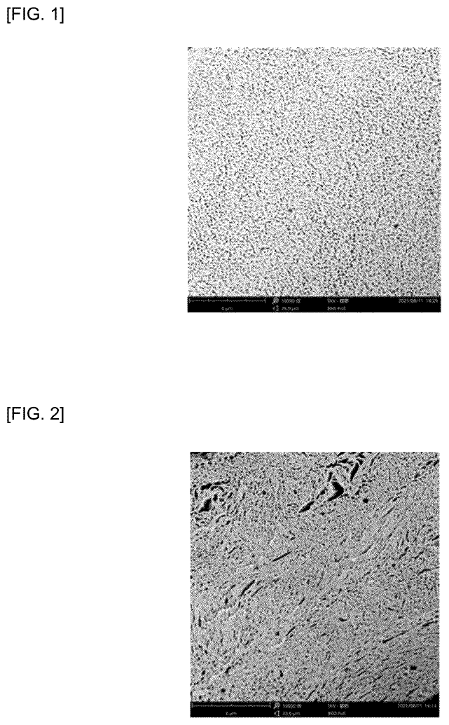

FIGS. 1 and 2 show scanning electron microscope photographs (with a magnification of 10,000) for confirming the dispersion state of the polycarbonate resin (B) in the resin composition. FIG. 1 is a photograph obtained by immersing a molded article sample of Example 2 in an organic solvent (chloroform) at room temperature, extracting the polycarbonate resin (B), then vacuum-drying, and thereafter subjecting a fracture surface of the molded article to a sputtering process and observing with a scanning electron microscope (for example, product name “Phenom Pro X” manufactured by Thermo Fisher Scientific Inc.). FIG. 2 is a photograph obtained by using the resin composition of Comparative Example 2, performing the same operations, and then observing with a scanning electron microscope. The sections observed as black shadows in FIGS. 1 and 2 show locations at which the polycarbonate resin (B) was present.

As shown in FIG. 1, in the resin composition of Example 2, the polycarbonate resin (B) takes on a small granular form and is uniformly dispersed. In the field of vision in FIG. 1, the maximum diameter (maximum straight-line distance) of a section observed as a black shadow is approximately 500 nm and is shorter the wavelength of the laser light (940 nm). As shown in FIG. 2, in the resin composition of Comparative Example 2, the polycarbonate resin (B) agglomerates in linear form or granular form, and has a non-uniform dispersion state.

As a non-limiting mechanism by which the hydrolysis resistance of a welded section of a laser-welded molded article improves, it is thought that by adding the carbodiimide compound (C), the carbodiimide compound (C) suppresses degradation of the polyalkylene terephthalate resin (A) caused by heat during laser welding, and furthermore, as degradation of the polyalkylene terephthalate resin (A) proceeds during heat-moisture processing, the carbodiimide compound (C) reacts with a carboxylic acid terminal of the polyalkylene terephthalate resin (A) included in both a laser light transmission-side molded article and a laser light absorption-side molded article, and the strength of molded article is maintained due to a crosslinking effect, etc.

The carbodiimide compound (C) is a compound that has a carbodiimide group (—N═C═N—) in a molecule thereof. Examples of the carbodiimide (C) compound include aliphatic carbodiimide compounds with an aliphatic main chain, alicyclic carbodiimide compounds with an alicyclic main chain, and aromatic carbodiimide compounds with an aromatic main chain. One or more selected from the foregoing compounds may be used.

Among these compounds, from the perspective that it is possible to further improve the laser light transmission rate of the molded article, the inclusion of an aromatic carbodiimide compound is preferred.

Examples of the aliphatic carbodiimide compounds include diisopropylcarbodiimide, dioctyldecylcarbodiimide, and the like. Examples of the alicyclic carbodiimide compounds include dicyclohexylcarbodiimide, and the like. Two or more of these compounds may be used in combination.

Examples of the aromatic carbodiimide compounds include: mono- or di-carbodiimide compounds such as diphenylcarbodiimide, di-2,6-dimethylphenylcarbodiimide, N-tolyl-N′-phenylcarbodiimide, di-p-nitrophenylcarbodiimide, di-p-aminophenylcarbodiimide, di-p-hydroxyphenylcarbodiimide, di-p-chlorophenylcarbodiimide, di-p-methoxyphenylcarbodiimide, di-3,4-dichlorophenylcarbodiimide, di-2,5-dichlorophenylcarbodiimide, di-o-chlorophenylcarbodiimide, p-phenylene-bis-di-o-tolylcarbodiimide, p-phenylene-bis-dicyclohexylcarbodiimide, p-phenylene-bis-di-p-chlorophenylcarbodiimide, and ethylene-bis-diphenylcarbodiimide, etc.; and polycarbodiimide compounds such as poly(4,4′-diphenylmethanecarbodiimide), poly(3,5′-dimethyl-4, 4′-biphenylmethanecarbodiimide), poly(p-phenylenecarbodiimide), poly(m-phenylenecarbodiimide), poly(3,5′-dimethyl-4, 4′-diphenylmethanecarbodiimide), poly(naphthylenecarbodiimide), poly(1,3-diisopropylphenylenecarbodiimide), poly(1-methyl-3,5-diisopropylphenylenecarbodiimide), poly(1,3,5-triethylphenylenecarbodiimide), and poly(triisopropylphenylenecarbodiimide), etc. Two or more of these compounds may be used in combination.

In particular, among the foregoing compounds, it is possible to suitably use one or more compounds selected from di-2,6-dimethylphenylcarbodiimide, poly(4,4′-diphenylmethanecarbodiimide), poly(phenylenecarbodiimide), and poly(triisopropylphenylenecarbodiimide).

The carbodiimide compound preferably has a number average molecular weight of 3000 or more. By configuring the number average molecular weight so as to be in the abovementioned range, it becomes easier to prevent the generation of gases and odors when the residence time of the thermoplastic resin during melt-kneading or molding of the thermoplastic resin is long.

The blended amount of the carbodiimide compound (C) is 0.1-3 parts by mass, preferably 0.5-2.5 parts by mass, more preferably 0.8-2.0 parts by mass, and further preferably 1.0-1.5 parts by mass with respect to 100 parts by mass of the polyalkylene terephthalate resin (A). By including 0.1-3 parts by mass of the carbodiimide compound (C) with respect to 100 parts by mass of the polyalkylene terephthalate resin (A), it is possible to raise the thermal stability when molten, the laser light transmission rate of a molded article, and the hydrolysis resistance of a laser-welded section in a laser-welded article.

In order to facilitate handling, it is also possible to use the carbodiimide compound (C) as a master batch in which the carbodiimide compound (C) is dispersed in a matrix resin. The type of the matrix resin is not particularly limited and may, for example, be the same as the polyalkylene terephthalate resin (A) described above, and may also be a different type of thermoplastic resin. The method for preparing the masterbatch is not particularly limited, and the masterbatch can be produced, for example, by melting and kneading the matrix resin and the carbodiimide compound (C) using an extruder.

### (Inorganic Filler (D))

The resin composition may also include an inorganic filler (D) with an objective of improving the mechanical properties of an obtained molded article. Examples of the inorganic filler (D) include fibrous fillers, tabular fillers, and granular fillers.

Examples of the fibrous fillers include: inorganic fibers such as glass fibers, asbestos fibers, silica fibers, alumina fibers, silica-alumina fibers, aluminum silicate fiber, zirconia fibers, potassium titanate fibers, and whiskers (whiskers of alumina, silicon nitride, or the like), etc.; and organic fibers such as aliphatic or aromatic polyamides, aromatic polyesters, fluororesins, acrylic resins such as polyacrylonitrile, and the like, and fibers formed from rayon, or the like. Examples of the tabular fillers include talc, mica, and glass flakes, etc.

Examples of the granular fillers include glass beads, glass powder, milled fibers (for example, milled glass fibers, or the like), and wollastonite, etc. Note that the wollastonite may be in a tabular form, a columnar form, or a fibrous form, etc. One type of the inorganic filler (D) may be used alone, and two or more types thereof may be combined and used. Among the foregoing, from the perspective of being cheap and easily available, etc., the inorganic filler (D) preferably includes glass fibers.

The average diameter of the fibrous filler may, for example, be approximately 1 μm to 30 μm (preferably 3 μm to 20 μm), and the average fiber length thereof may, for example, be approximately 100 μm to 5 mm (preferably 300 μm to 4 mm and further preferably 500 μm to 3.5 mm). Further, the average primary particle diameter of the tabular or granular filler can be set so as to be, for example, approximately 10 μm to 500 μm and preferably approximately 15 μm to 100 μm.

Note that the average diameter and average fiber length of the fibrous filler, and the average primary particle diameter of the tabular or granular filler are values for the fibrous filler and the tabular or granular filler prior to being blended in the resin composition, obtained by analyzing an image captured by a CCD camera and calculating a weighted average. Said values can be calculated by using, for example, the product “Dynamic Image Analysis Method/Particle (state) Analyzer PITA-3” manufactured by Seishin Enterprise Co., Ltd.

The content of the inorganic filler (D) is 0-100 parts by mass, preferably 10-90 parts by mass, more preferably 30-85 parts by mass, and further preferably 50-80 parts by mass with respect to 100 parts by mass of the polyalkylene terephthalate resin (A).

### (Inorganic Phosphorus Compound (E))

The resin composition includes an inorganic phosphorus compound (E). By further including the inorganic phosphorus compound (E) in a resin composition in which the polycarbonate resin (B) and the carbodiimide compound (C) are blended in the polyalkylene terephthalate resin (A), it is possible to further raise thermal stability of the resin composition during retention.

Examples of the inorganic phosphorus compound (E) include inorganic phosphoric acids (phosphoric acid, phosphorous acid, phosphonic acid, phosphinic acid, pyrophosphoric acid, tripolyphosphoric acid, polyphosphoric acid, polyphosphorous acid, phosphonocarboxylic acid, and nitrogen-containing phosphoric acid, etc.) and acidic metal salts thereof.

Examples of the acidic metal salts of the inorganic phosphoric acids include inorganic hydrogen phosphate alkali metal salts (for example, (pyro)hydrogen phosphate alkali metal salts such as LiH₂PO₄, NaH₂PO₄, NaH₂PO₄·2H₂O, Na₂H₂P₂O₇, KH₂PO₄, K₂H₂P₂O₇, etc.), inorganic hydrogen phosphate alkaline earth metal salts (for example, (pyro) hydrogen phosphate alkaline earth metal salts such as Ca(H₂PO₄)₂, Ca(H₂PO₄)₂·H₂O, CaH₂P₂O₇, Mg(H₂PO₄)₂, MgH₂P₂O₇, etc.), and inorganic aluminum hydrogen phosphate salts (for example, Al(H₂PO₄)₃, etc.). One type of the inorganic phosphorus compound may be used alone, and two or more types thereof may also be combined and used.

In one embodiment, the inorganic phosphorus compound (E) preferably includes monocalcium phosphate (Ca(H₂PO₄)₂).

The content of the inorganic phosphorus compound (E) is preferably 0.01-5 parts by mass, more preferably 0.05-3 parts by mass, further preferably 0.08-1 parts by mass, and particularly preferably 0.08-0.5 parts by mass with respect to 100 parts by mass of the polyalkylene terephthalate resin (A).

From the perspective of further raising improvement effects on thermal stability, the resin composition may also include an organic phosphorus compound. The content of the organic phosphorus compound in the resin composition is preferably 0.1 parts by mass or more and less than 1.5 parts by mass, and more preferably 0.2 parts by mass or more and less than 0.5 parts by mass with respect to 100 parts by mass of the polyalkylene terephthalate resin (A).

In one embodiment, the resin composition preferably includes a phosphorus-based compound consisting of the inorganic phosphorus compound (E).

(Epoxy resin (F))

The resin composition may also include an epoxy resin (F) in order to further raise the hydrolysis resistance of the resin composition itself. Examples of the epoxy resin (F) include aromatic epoxy resins such as biphenyl-type epoxy resins, bisphenol A-type epoxy resins, phenol novolak-type epoxy resins, and cresol novolak-type epoxy resins, etc. Two or more epoxy resins may be arbitrarily combined and used as the epoxy resin. The epoxy equivalent weight is preferably 150-1500 g/eq.

In one embodiment, the resin composition preferably includes a bisphenol A-type epoxy resin.

The content of the epoxy resin (F) is preferably 0-10 parts by mass, more preferably 0.5-8 parts by mass, further preferably 1-5 parts by mass, and particularly preferably 1-3 parts by mass with respect to the polyalkylene terephthalate resin (A).

### (Other Additives)

Various other additives such as stabilizers (antioxidants, ultraviolet absorbers, etc.), flame retardants, lubricants, mold release agents, anti-static agents, colorants such as dyes, pigments, or the like, dispersing agents, plasticizers, nucleating agents, etc., may also be added to the resin composition. In such a case, the content of the additive can, for example, be set so as to be more than 0 parts by mass and no more than 20 parts by mass with respect to 100 parts by mass of the polyalkylene terephthalate resin (A). Note that regarding colorants, when design requirements demand that a similar appearance as the laser light absorption-side molded article, and in particular when required to be colored a black tone, in order to prevent laser light transmission properties from being impaired, it is desirable to use a dye-based colorant or to use a pigment that does not impair the laser light transmission rate (for example, Lumogen® black manufactured by BASF).

The resin composition may also contain another resin as necessary. Examples of the other resin include olefin-based elastomers, styrene-based elastomers, polyester-based elastomers, and core-shell polymers, etc.

In order to further raise the laser light transmission rate, the resin composition does not include a laser light-absorbing compound, or the proportion of the laser light-absorbing compound in the resin composition is preferably less than 0.01 mass %. Examples of the laser light-absorbing compound include carbon black, lanthanum hexaboride, and cesium tungsten oxide, etc.

### (Resin Composition)

The method for manufacturing the resin composition is not particularly limited and examples thereof include a method in which a melt-kneading device such as a single- or twin-screw extruder is used to melt-knead respective components and extrude to obtain pellets, and a method in which pellets (masterbatch) having different constitutions are prepared and these pellets are blended at prescribed amounts.

The resin composition has excellent thermal stability during retention, the laser light transmission rate of molded articles is improved, and furthermore, the hydrolysis resistance in welded sections of laser-welded molded articles is excellent. As such, the resin composition can be preferably used to manufacture laser light transmission-side molded articles among molded articles which are to undergo laser welding.

In one embodiment, when three cycles each involving an operation of increasing the temperature of the resin composition from 50° C. to 280° C. at a temperature increase rate of 10° C./minute and thereafter decreasing the temperature to 50° C. at a temperature decrease rate of −10° C./minute are performed, a difference between the crystallization temperature in the first cycle and the crystallization temperature in the third cycle, as measured by differential scanning calorimetry (DSC) on the basis of JIS K 7121, is preferably 5° C. or less, more preferably 4.8° C. or less, and further preferably 1.5° C. or less.

### [Molded Article]

A molded article according to the present embodiment (hereinafter also referred to simply as the “molded article”) is a laser light transmission-side molded article which includes the resin composition described above. The molded article includes the resin composition described above, and therefore, thermal degradation caused by retention during molding is suppressed and the laser light transmission rate is also improved. Further, when laser-welded, the hydrolysis resistance of laser-welded sections is excellent.

In one embodiment, the ratio (T1/T2) of the laser light transmission rate (T1) of a molded article of the resin composition described above with respect to the laser light transmission rate (T2) of a molded article of a resin composition which does not include the carbodiimide compound (B) is preferably 1.10 or more, more preferably 1.20 or more, and further preferably 1.30 or more. A “resin composition which does not include the carbodiimide compound (B)” indicates a resin composition which, other than not including the carbodiimide compound (B), has the same constitution as the resin composition described above. The laser light transmission rate is the transmission rate of a laser light with a wavelength of 940 nm in an optical path length of 2.0 mm. The laser light transmission rate is a value measured using a spectrophotometer.

In one embodiment, the molded article has a laser light transmission rate, for a laser light with a wavelength of 940 nm in a 2.0 mm optical path length, of preferably 55% or more and more preferably 60% or more. In one embodiment, when the molded article includes a colorant, the transmission rate of a laser light with a wavelength of 940 nm in a 2.0 mm optical path length is preferably 30% or more.

The molded article itself has excellent hydrolysis resistance. In one embodiment, after being subjected to a heat-moisture treatment (85° C., 85% humidity, 1000 hours) in a constant-temperature, constant-humidity chamber, the tensile strength, measured in compliance with ISO 527-1 and 2, of the molded article is preferably a retention rate of 70% or more, more preferably a retention rate of 80% or more, and further preferably a retention rate of 85% or more with respect to the tensile strength before the heat-moisture treatment. The molded article can improve hydrolysis resistance of a laser-welded section in the case of being laser-welded.

The molded article is manufactured by using the resin composition described above. The method for manufacturing the molded article is not particularly limited, and it is possible to form the molded article by a conventional method such as performing melt-kneading, extrusion molding, injection molding, compression molding, blow molding, vacuum molding, rotary molding, gas injection molding, or the like, on the resin composition. Normally, molding is performed by injection molding. Note that the mold temperature during injection molding is normally 40-90° C., preferably 50-80° C., and more preferably approximately 60-80° C.

The shape of the molded article is not particularly limited but is normally a shape (for example, a tabular shape) that at least has a contact surface (flat surface, or the like) to enable the molded article to be used by being joined to a counterpart material (laser light absorption-side molded article) by laser welding. Further, the molded article has a high transmittivity with respect to laser light, and therefore, the thickness of the molded article at a location that is to transmit laser light (thickness in a direction that transmits laser light) can be selected from a wide range, and for example, is 0.3 mm-5 mm, and preferably approximately 0.5 mm-3 mm (for example, 1 mm-2 mm).

### [Composite Molded Article]

A composite molded product according to the present embodiment (hereinafter also referred to simply as the “composite molded article”) includes: a laser light transmission-side molded article (hereinafter also referred to as the “first molded article”) which includes the resin composition described above; and a laser light absorption-side molded article (hereinafter also referred to as the “second molded article”). The laser light transmission-side molded article is the same as the laser light transmission-side molded article described above.

As long as it is a resin composition that is compatible with the resin composition constituting the first molded article, the resin composition constituting the second molded article is not particularly limited, and examples thereof include resin compositions including a resin such as an olefin-based resin, a vinyl-based resin, a styrene-based resin, an acrylic resin, a polyester-based resin, a polyamide-based resin, a polycarbonate-based resin, and the like. The resin composition constituting the second molded article may also include a resin (an aromatic polyester-based resin such as PBT-based resin, a PET-based resin, etc., and/or a polycarbonate-based resin) of the same type or same system as a resin included in the resin composition constituting the first molded article.

The second molded article may also include a colorant or absorber for laser light. The colorant can be selected in accordance with the wavelength of the laser light, and an inorganic pigment or an organic pigment can be used. Examples of the inorganic pigment include black pigments such as carbon black (for example, acetylene black, lamp black, thermal black, furnace black, channel black, Ketjenblack, and the like), etc., red pigments such as iron oxide red, orange pigments such as molybdate orange, and white pigments such as titanium oxide. Examples of the organic pigment include yellow pigments, orange pigments, red pigments, blue pigments, and green pigments, etc. These absorbers may be used alone or as a combination of two or more. It is normally possible to use a black pigment or dye, and in particular carbon black as the absorber. The primary particle diameter of carbon black is normally 1 nm-1000 nm, and may preferably be approximately 10 nm-100 nm. The ratio of the colorant is 0.1 mass %-10 mass % and preferably approximately 0.5 mass %-5 mass % (for example, 0.5 mass %-3 mass %) with respect to the entire resin composition constituting the second molded article.

Laser light is normally irradiated oriented in the direction of the second molded article from the first molded article, and by generating heat at the interface with the second molded article, which has light absorption properties, the first molded article and the second molded article are fused. Note that, as necessary, a lens system may be used to concentrate laser light on the interface between the first molded article and the second molded article and fuse the contact interface. The laser light source is not particularly limited, and it is possible to use, for example, a dye laser, a gas laser (excimer laser, argon laser, krypton laser, helium-neon laser, etc.), a solid state laser (YAG laser, etc.), a semiconductor laser, or the like. A pulse laser is normally used as the laser light.

The composite molded article has excellent hydrolysis resistance in laser-welded sections. In one embodiment, after the composite molded article is subjected to a heat-moisture treatment (85° C., 85% humidity, 1000 hours) in a constant-temperature, constant-humidity chamber, the tensile strength of a laser-welded section thereof is preferably a retention rate of 50% or more, more preferably a retention rate of 60% or more, and further preferably a retention rate of 70% or more with respect to the tensile strength of the laser-welded section before the heat-moisture treatment.

### [Method for Improving Laser Light Transmission Properties]

The method for improving the laser light transmission properties according to the present embodiment is a method in which the laser light transmission properties of the resin composition are improved, and includes blending 0.1-3 parts by mass of the carbodiimide compound (C) in a resin composition including 100 parts by mass of the polyalkylene terephthalate resin (A), 10-100 parts by mass of the polycarbonate resin (B), 0-100 parts by mass of the inorganic filler (D), and the inorganic phosphorus compound (E). Due to research by the present inventors, it was confirmed that by adding the carbodiimide compound (C) to a laser welding resin composition comprising an alloy material of the polyalkylene terephthalate resin (A) and the polycarbonate resin (B), the laser light transmission rate of a molded article including the resin composition improves. Although the mechanism is not currently clear, as shown in FIGS. 1 and 2, by adding the carbodiimide compound (C), the polycarbonate resin (B) has a smaller dispersion diameter in the resin composition and is uniformly dispersed. Due thereto, it is thought that scattering of light at the interface between the polyalkylene terephthalate resin (A) and the polycarbonate resin (B) decreases and the laser light transmission properties of the molded article of the resin composition improve.

By including the carbodiimide compound (C), it is possible to improve the laser light transmission rate of the resin composition molded article even when the inorganic phosphorus compound (E) is included. By including the carbodiimide compound (C), it is possible to improve the laser light transmission rate of the resin composition in the resin composition molded article even when a colorant is included.

The “laser light transmission properties improve” means that a laser light transmission rate (T1) of a resin composition including the carbodiimide compound (C) is higher than a laser light transmission rate (T2) of a resin composition that does not include the carbodiimide compound (C).

In one embodiment, the method for improving the laser light transmission properties is preferably a method which makes a ratio (T1/T2) of the laser light transmission rate (T1) of a molded article of the resin composition with respect to the laser light transmission rate (T2) of a molded article of a resin composition which does not include the carbodiimide compound (C) 1.10 or more, more preferably a method which makes said ratio 1.20 or more, and further preferably a method which makes said ratio 1.30 or more. A “resin composition which does not include the carbodiimide compound (C)” indicates a resin composition which, other than not including the carbodiimide compound (C), has the same constitution as the resin composition described above. The laser light transmission rate is the transmission rate of a laser light with a wavelength of 940 nm in a 2.0 mm optical path length. The laser light transmission rate is a value measured using a spectrophotometer.

### EXAMPLES

The present invention shall be explained in more detail by referring to the examples below. However, the interpretation of the present invention is not to be limited by these examples.

### Materials

The materials used in the examples and comparative examples are as described below.
A: Polyalkylene terephthalate resin (PBT)
A-1: Polybutylene terephthalate manufactured by Polyplastics Co., Ltd., intrinsic viscosity (IV): 0.69 dL/g
A-2: Isophthalic acid 12.5 mol modified polyethylene terephthalate resin, manufactured by Polyplastics Co., Ltd.
B: Polycarbonate resin (PC)
Product name “Panlite®”, manufactured by Teijin Ltd., melt viscosity: 0.27 kPa·s
C: Carbodiimide compound
Aromatic carbodiimide, product name “Stabaxol® P-100”, manufactured by Lanxess
D: Inorganic filler (GF)
Glass fibers, product name “T-127”, manufactured by manufactured by Nippon Electric Glass Co., Ltd., average fiber diameter: 13 μm
E: Phosphorus-based compound
E-1: Monocalcium phosphate
E-2: Product name “ADK STAB® AX-71” (mixture of mono- and di-stearyl acid phosphates), manufactured by Adeka Corporation
E-3: Product name “ADK STAB PEP-36” (bis(2,6-di-t-butyl-4-methylphenyl)pentaerythritol diphosphite), manufactured by Adeka Corporation
F: Epoxy resin
Product name “Epicoat 1004”, manufactured by Mitsubishi Chemical Group Corporation
G: Antioxidant
“Irganox®1010”, manufactured by BASF Japan
H: Nucleating agent
Boron nitride
I: Colorant
I-1: Pigment Blue 15.3
I-2: Pigment Yellow 181
I-3: Pigment Red 149
J: Elastomer
Polyester elastomer, product name “Pelprene® P-90BD”, manufactured by Toyobo MC Corporation
K: Lubricant
Product name “Rikemal® B-74”, manufactured by Riken Vitamin Co., Ltd.

### Examples 1-3 and Comparative Examples 1-8

The materials show in Tables 1 and 2 were kneaded, at the contents shown in Tables 1 and 2, by using a twin-screw extruder (manufactured by The Japan Steel Works, Ltd., 30 mm (φ at 260° C. to fabricate resin composition pellets. Note that Example 3 and Comparative Example 8 are examples in which a colorant is included.

### Measurement and Evaluation

The following physical properties were measured and evaluated for the resin composition pellets of the examples and comparative examples. The results are shown in Tables 1 and 2.

### (Laser Light Transmission Properties)

The resin composition pellets were injection-molded with a cylinder temperature of 260° C. and a mold temperature of 80° C. to obtain test pieces (80 mm×80 mm×2 mm in thickness). For the obtained test pieces, the laser light transmission rate at a wavelength of 940 nm and an optical path length of 2.0 mm was measured using a spectrophotometer (product name “V-770”, manufactured by Jasco Corporation).

### (Hydrolysis Resistance of Resin Composition Molded Article)

After being dried for three hours at 140° C., the resin composition pellets obtained in the examples and the comparative examples were injection-molded with a cylinder temperature of 260° C. and a mold temperature of 80° C. to fabricate Type 1A tensile test pieces in compliance with ISO 3167. The tensile strength of the obtained test pieces was measured in compliance with ISO 527-1,2.

Next, the test pieces were subjected to a heat-moisture treatment in a constant-temperature, constant-humidity chamber (85° C., 85% humidity, 1000 hours) and the tensile strength after the heat-moisture treatment was measured in compliance with ISO 527-1, 2. Strength retention after compared to before the heat-moisture treatment [(tensile strength after heat-moisture treatment/tensile strength before heat-moisture treatment)×100(%)] was calculated.

### (Observation of Fracture Surface of Resin Composition Molded Article)

After being dried for three hours at 140° C., the resin composition pellets obtained in Example 2 and Comparative Example 2 were each injection-molded with a cylinder temperature of 260° C. and a mold temperature of 80° C. to obtain Type 1A tensile test pieces in compliance with ISO 3167. The obtained molded articles were cut in the vertical direction between marked lines by using a diamond cutter (product name “IsoMet 1000”) manufactured by Buehler. One cut surface of the obtained cut articles was cut using a microtome and immersed at room temperature using an organic solvent (chloroform) to extract the polycarbonate resin (B). Thereafter, vacuum drying and sputtering processes were performed and observation at a magnification of 10,000 was performed using a scanning electron microscope “product name “Phenom Pro X”, manufactured by Thermo Fisher Scientific, Inc.). FIGS. 1 and 2 show scanning electron microscope photographs (with a magnification of 10,000).

### (Fabrication of Laser-Welded Article)

The resin composition pellets obtained in the examples and the comparative examples were used as a laser light transmitting material. Resin compositions obtained by adding a PBT masterbatch having a carbon black concentration of 20 mass % to each of the above resin composition pellets so that the mass ratio of the resin composition and the PBT masterbatch (resin composition: PBT masterbatch) therein is a ratio of 19:1 were used as absorption materials.

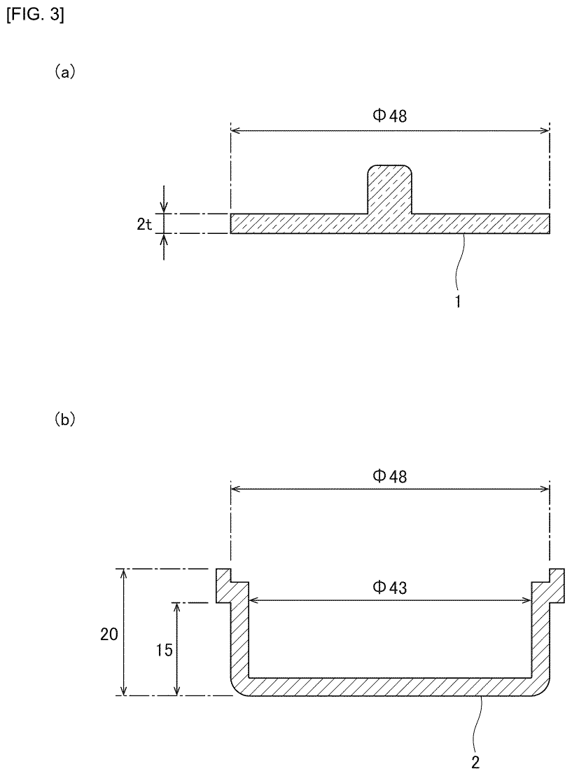

Resin composition pellets as the laser light transmitting material were dried for three hours at 140° C. and then injection molded with a cylinder temperature of 260° C. and a mold temperature of 80° C. to obtain a laser light transmission-side molded article 1 (first molded article) having the shape shown in FIG. 3(a). The laser light transmission-side molded article 1 shown in FIG. 3(a) is a disk shape having a diameter of 48 mm and thickness of 2 mm, has a projection in a central section of a main surface on one side of the disk, and has an overall shape of a pot lid.

Resin composition pellets as the laser light absorbing material were dried for three hours at 140° C. and then injection molded with a cylinder temperature of 260° C. and a mold temperature of 80° C. to obtain a laser light absorption-side molded article 2 (second molded article) having the shape shown in FIG. 3(b). The laser light absorption-side molded article 2 shown in FIG. 3(b) has a pot shape which is hollow, has an entirely open upper surface, and has a thickness of 2.5 mm, an inner diameter of 43 mm, and a height of 20 mm. The laser light absorption-side molded article 2 has, at a height of 15 mm, an outwardly spreading peripheral section with a width of 2.5 mm and a thickness of 0.5 mm, and an open section having a diameter of 48 mm and extending 5 mm vertically from the bottom surface of the peripheral section is formed.

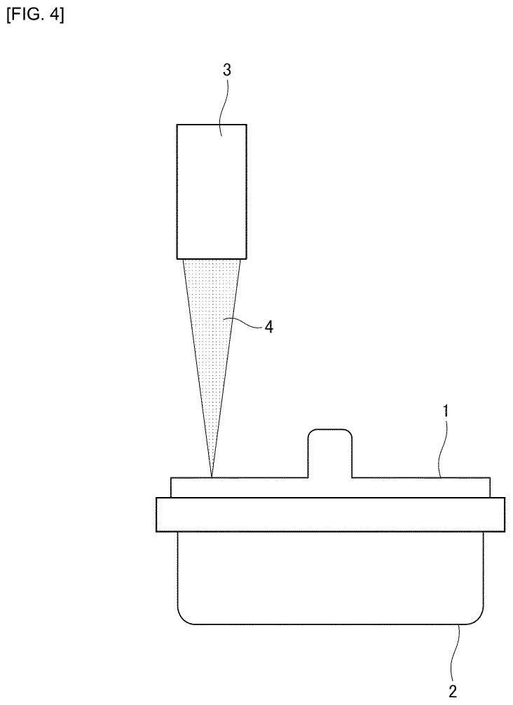

FIG. 4 shows a schematic explanatory diagram illustrating a laser light being irradiated. As shown in FIG. 4, with the laser light transmission-side molded article 1 (first molded article) fitted in the peripheral section of the laser light absorption-side molded article 2 (second molded article) and the open section of the laser light absorption-side molded article 2 (second molded article) blocked, laser welding was performed using a laser welding device (product name “FD-2430”, manufactured by Fine Device Co., Ltd) to irradiate a laser light 4 from a laser head 3 from the laser light transmission-side molded article 1 (first molded article) side at an irradiation rate of 10 mm/sec. and an irradiation diameter of 1.6 mm to obtain a laser-welded article (composite molded article). In the composite molded article, the open section of the laser light absorption-side molded article (second molded article) is blocked by the laser light transmission-side molded article (first molded article). The peripheral section with a width of 5 mm is the laser-welded section.

### (Hydrolysis Resistance of Laser-Welded Section)

The initial breaking strength of the laser-welded section of the laser-welded article (composite molded article) obtained in the manner described above was measured using a universal testing machine with the product name “Autograph AG-Xplus” manufactured by Shimadzu Corporation with a testing speed of 10 mm/min.

Next, the laser-welded article was subjected to a heat-moisture treatment in a constant-temperature, constant-humidity chamber (85° C., 85% humidity, 1000 hours), and the breaking strength of the laser-welded section after the heat-moisture treatment was measured under the same conditions as those described above.

Strength retention after compared to before the heat-moisture treatment [(tensile strength after heat-moisture treatment/tensile strength before heat-moisture treatment)×100(%)] was calculated. A strength retention of 70% or more was rated A and less than 70% was rated B.

### (Thermal Stability)

A differential scanning calorimeter (product name “DSC Q-1000”, manufactured by T A Instruments) was used to perform three cycles of an operation in which the resin composition pellets obtained in the examples or comparative examples were heated to 280° C. and melted, then lowered to a temperature of 50° C., thereafter increased from 50° C. to 280° C. at a temperature increase rate of 10° C./minute, kept in a 280° C. environment for five minutes, and then lowered to 50° C. at a temperature decrease rate of 10° C./min. A difference (Tc1-Tc3) between a crystallization temperature Tc1 detected in the first cycle and a crystallization temperature Tc3 detected in the third cycle was calculated as ΔTc.

Resin composition pellets in which all ΔTc were 5° C. or less were rated A and those in which ΔTc exceeded 5° C. were rated B.

TABLE 1

| | | Example/Comparative Example | | | | | | | | |
|---|---|---|---|---|---|---|---|---|---|---|
| | | | | Comp | Comp | Comp | Comp | Comp | Comp | Comp |
| | | Ex 1 | Ex 2 | Ex 1 | Ex 2 | Ex 3 | Ex 4 | Ex 5 | Ex 6 | Ex 7 |
| PBT | A-1 | 100.0 | 100.0 | 100.0 | 100.0 | 100.0 | 100.0 | 100.0 | 100.0 | 100.0 |
| | A-2 | | | | | | | | | |
| PC | B-1 | 79.1 | 77.0 | 78.0 | 76.0 | 77.9 | 76.0 | | 79.1 | 80.0 |
| Carbodiimide | C | 1.3 | 1.3 | | | | 0.03 | | 1.3 | 1.3 |
| GF | D-3 | 79.1 | 77.0 | 78.0 | 76.0 | 77.9 | 76.0 | 42.9 | 79.1 | 80.0 |
| Phosphorus- | E-1 | 0.1 | 0.1 | 0.1 | 0.1 | | 0.1 | | | |
| based | E-2 | | | | | | | | 0.1 | |
| Compound | E-3 | | | | | | | | | 1.3 |
| Epoxy Resin | F | 2.6 | | 2.6 | | 2.6 | | | 2.6 | 2.7 |
| Antioxidant | G | | | | | | | | | |
| Nucleating Agent | H | | | | | | | | | |
| Colorant | I-1 | | | | | | | | | |
| | I-2 | | | | | | | | | |
| | I-3 | | | | | | | | | |
| Elastomer | J | | | | | | | | | |
| Lubricant | K | 1.3 | 1.3 | 1.3 | 1.3 | 1.3 | 1.3 | | 1.3 | 1.3 |
| Transmission | 940 nm transmission | 63 | 64 | 50 | 46 | 82 | 51 | 18 | 63 | 70 |
| Rate | rate 2 mmt (%) | | | | | | | | | |
| Hydrolysis | Tensile test piece | 89 | 86 | 69 | 77 | 73 | 78 | 76 | 88 | 88 |
| Resistance | Strength retention (%) | | | | | | | | | |
| | 85° C. × 85% Rh × 1000 hr | | | | | | | | | |
| Hydrolysis | Laser-welded test piece | 73 | 75 | 29 | 35 | 33 | 35 | 35 | 70 | 72 |
| Resistance | Strength retention (%) | | | | | | | | | |
| | 85° C. × 85% Rh × 1000 hr | | | | | | | | | |
| | Rating | A | A | B | B | B | B | B | A | A |
| Thermal Stability | Tc1 (° C.) | 184.8 | 185.2 | 186.7 | 193.0 | 174.7 | 185.8 | 194.0 | 183.2 | 180.5 |
| | Tc3 (° C.) | 180.2 | 184.2 | 174.3 | 185.7 | 160.2 | 177.4 | 193.9 | 176.1 | 167.6 |
| | ΔTc (Tc1 − Tc3) (° C.) | 4.5 | 1.0 | 12.4 | 7.3 | 14.5 | 6.9 | 0.2 | 7.1 | 12.9 |
| | Rating | A | A | B | B | B | B | A | B | B |

TABLE 2

| Example/Comparative Example | | Ex 3 | Comp Ex 8 |
|---|---|---|---|
| PBT | A-1 | | |
| | A-2 | 100.0 | 100.0 |
| PC | B-1 | 24.6 | 24.2 |
| Carbodiimide | C | 1.0 | |
| GF | D-3 | 60.0 | 59.2 |
| Phosphorus- | E-1 | 0.1 | 0.1 |
| based | E-2 | | |
| Compound | E-3 | | |
| Epoxy Resin | F | 2.0 | 2.0 |
| Antioxidant | G | 0.6 | 0.6 |
| Nucleating Agent | H | 0.02 | 0.02 |
| Colorant | I-1 | 0.2 | 0.5 |
| | I-2 | 0.3 | 0.3 |
| | I-3 | 0.3 | 0.3 |
| Elastomer | J | 10.0 | 9.9 |
| Lubricant | K | 0.6 | 0.6 |
| Transmission | 940 nm transmission rate 2 mmt (%) | 30 | 27 |
| Rate | | | |
| Hydrolysis | Tensile test piece | 94 | 89 |
| Resistance | Strength retention (%) | | |
| | 85° C. × 85% Rh × 1000 hr | | |
| Hydrolysis | Laser-welded test piece | 95 | 30 |
| Resistance | Strength retention (%) | | |
| | 85° C. × 85% Rh × 1000 hr | | |
| | Rating | A | B |
| Thermal Stability | Tc1 (° C.) | 187.2 | 188.3 |
| | Tc3 (° C.) | 184.4 | 184.3 |
| | ΔTc (Tc1 − Tc3) (° C.) | 2.8 | 4.0 |
| | Rating | A | A |

As shown in Table 1, the resin compositions of Examples 1 and 2 have excellent thermal stability, with ΔTc no more than 5° C. for both. Molded articles have an improved laser light transmission rate at a wavelength of 940 nm for the resin compositions of Examples 1 and 2 compared with the resin compositions of Comparative Examples 1 and 2. The ratio (T1/T2) of the laser light transmission rate (T1) of Example 1 with respect to the laser light transmission rate (T2) of Comparative Example 1 was 1.26, and the ratio (T1/T2) of the laser light transmission rate (T1) of Example 2 with respect to the laser light transmission rate (T2) of Comparative Example 2 was 1.39. For the resin compositions of Examples 1 and 2, the hydrolysis resistance of a resin composition molded article is excellent, and the hydrolysis resistance of laser-welded sections in laser-welded articles is also excellent. From comparing Example 1 against Comparative Example 1, and Example 2 against Comparative Example 2, the improvement effects on hydrolysis resistance due to adding the carbodiimide compound (C) are understood to be more remarkable in a joined section (laser-welded article) compared to a case of a transmission-side resin composition single body (resin composition molded article).

In the resin compositions of Comparative Examples 1 and 2 which do not include the carbodiimide compound (C), thermal stability deteriorates and hydrolysis resistance in laser-welded sections of laser-welded articles is also low.

In the resin composition of Comparative Example 3 which does not include the carbodiimide compound (C) or the inorganic phosphorus compound (E), although the laser light transmission rate of the molded article is high, thermal stability and hydrolysis resistance in laser-welded sections of laser-welded articles are low. From comparing Comparative Example 1 and Comparative Example 3, it is understood that in a resin composition that does not include the carbodiimide compound (C), although ΔTc becomes small and thermal stability improves by adding the inorganic phosphorus compound (E), the laser light transmission rate reduced significantly from 82% to 50%. In contrast thereto, in Example 1 which includes the carbodiimide compound (C), it is possible to realize a laser light transmission rate of 60% or more. In the resin composition of Example 1, the laser light transmission rate at a wavelength of 940 nm is improved compared to the resin composition of Comparative Example 1.

For the resin composition of Comparative Example 4 in which the content of the carbodiimide compound (C) is less than 0.1 parts by mass, the laser light transmission rate of the molded article is low and hydrolysis resistance in laser-welded sections of laser-welded articles is low.

For the resin composition of Comparative Example 5 which does not include the carbonate resin (B), the carbodiimide compound (C), or the inorganic phosphorus compound (E), although thermal stability is high, the laser light transmission rate of the molded article is low and the hydrolysis resistance in laser-welded sections of laser-welded articles is low.

For the resin compositions of Comparative Examples 6 and 7 which include an organic phosphorus compound instead of the inorganic phosphorus compound (E), the result was a low thermal stability.

As shown in Table 2, even for a resin composition including a colorant, molded articles have an improved laser light transmission at a wavelength of 940 nm for the resin composition of Example 3 compared with the resin composition of Comparative Example 8. For the resin composition of Examples 3, the hydrolysis resistance of resin composition molded articles is excellent, and the hydrolysis resistance of laser-welded sections in laser-welded articles is also excellent.

### INDUSTRIAL APPLICABILITY

The resin composition according to the present invention has excellent thermal stability, laser light transmission properties, and hydrolysis resistance in laser-welded sections, and therefore, can be favorably utilized as a laser light transmission-side molded article.

### REFERENCE SIGNS LIST

1 Laser light transmission-side molded article
2 laser light absorption-side molded article
3 Laser head
4 Laser light

1. A resin composition for a laser light transmission-side molded article, the resin composition comprising:
100 parts by mass of a polyalkylene terephthalate resin (A);
10-100 parts by mass of a polycarbonate resin (B);
0.1-3 parts by mass of a carbodiimide compound (C);
0-100 parts by mass of an inorganic filler (D); and
an inorganic phosphorus compound (E).

2. The resin composition according to claim 1, wherein when three cycles of an operation involving increasing the temperature from 50° C. to 280° C. at a temperature increase rate of 10° C./minute and thereafter decreasing the temperature to 50° C. at a temperature decrease rate of −10° C./minute are performed, a difference between the crystallization temperature in the first cycle and the crystallization temperature in the third cycle, as measured by differential scanning calorimetry on the basis on JIS K 7121, is 5° C. or less.

3. The resin composition according to claim 1, further comprising an epoxy resin (F).

4. A laser light transmission-side molded article comprising the resin composition according to claim 1.

5. A composite molded article comprising: a laser light transmission-side molded article comprising the resin composition according to claim 1; and a laser light absorption-side molded article.

6. A method for producing a composite molded article in which at least a portion of a first molded article comprising the resin composition according to claim 1 and at least a portion of a second molded article comprising a resin composition comprising a polyalkylene terephthalate resin and a laser light absorption agent are stacked, and at least a portion of the first molded article and at least a portion of the second molded article are welded by irradiating a laser light from the first molded article side.

7. A method for improving laser light transmission properties of a resin composition molded article, the method comprising
blending 0.1-3 parts by mass of a carbodiimide compound (C) in a resin composition comprising 100 parts by mass of a polyalkylene terephthalate resin (A), 10-100 parts by mass of a polycarbonate resin (B), 0-100 parts by mass of an inorganic filler (D), and an inorganic phosphorus compound (E).

8. The resin composition according to claim 2, further comprising an epoxy resin (F).

9. A laser light transmission-side molded article comprising the resin composition according to claim 2.

10. A composite molded article comprising: a laser light transmission-side molded article comprising the resin composition according to claim 2; and a laser light absorption-side molded article.

11. A method for producing a composite molded article in which at least a portion of a first molded article comprising the resin composition according to claim 2 and at least a portion of a second molded article comprising a resin composition comprising a polyalkylene terephthalate resin and a laser light absorption agent are stacked, and at least a portion of the first molded article and at least a portion of the second molded article are welded by irradiating a laser light from the first molded article side.
